(19) United States
(12) Patent Application Publication
(10) Pub. No.: US 2008/0146249 A1
(43) Pub. Date: Jun. 19, 2008

(54) METHOD OF DETERMINING AND PROVIDING MOBILE COMMUNICATIONS LOCATION INFORMATION

(75) Inventors: Assaf Landschaft, Munich (DE); Laurent Mauguee, Muenchen (DE)

Correspondence Address: HITT GAINES, PC;LSI Corporation, PO BOX 832570, RICHARDSON, TX, 75083, US

(73) Assignee: Agere Systems, Inc., Allentown, PA (US)

(21) Appl. No.: 11/611,366

(22) Filed: Dec. 15, 2006

(51) Int. Cl. H04Q 7/20

(52) U.S. Cl. 455/456.3

(57) ABSTRACT

Introduced is a method of providing a user location information with a mobile communications device. In one embodiment, the method includes (1) determining a cell location within a communications network that is in communication with the user's mobile communications device; (2) utilizing the cell location to determine a geographic location of the user's mobile communications device; and providing the geographic location to the user via the user's mobile communications device.

### TECHNICAL FIELD OF THE INVENTION

The present invention is directed, in general, to a mobile communications device locator and, more specifically to a method for determining the location of a mobile communications device in a communications network and providing such information to the user of the mobile communications device.

### BACKGROUND OF THE INVENTION

Users of mobile communications devices, in particular cellular phones, traveling by automobile as well as other modes of transportation, often have no idea what their actual geographic position is. Such information can, on occasion, be of vital importance, such as when the user is in an accident and must seek help. It also provides a convenience factor. For example, if a person traveling between New York and Boston on a high-speed train gets a phone call, he or she will have a convenient way to ascertain his or her approximate location in order to give the caller an approximate location.

Standard mobile phones do not offer this kind of information. Only those mobile phones that also equipped with GPS can provide such information. However, mobile phones with GPS capability are very expensive and not very common.

Accordingly, what is needed in the art is an advanced mobile communications device that provides a low cost location service to enable a user to ascertain his or her approximate location.

### SUMMARY OF THE INVENTION

To address the above-discussed deficiencies in the prior art, the present invention provides a method of providing a user of a mobile communications device location information. In one embodiment, the method includes (1) determining a cell location within a communications network that is in communication with the user's mobile communications device; (2) utilizing the cell location to determine a geographic location of the user's mobile communications device; and providing the geographic location to the user via the user's mobile communications device.

Thus the present invention permits a user to utilize a mobile communications device to ascertain his or her position within a mobile communications network. The mobile communications device utilizes network information to ascertain its position and communicates this information to the user.

One embodiment of the method provided for the communications network to be operated in accordance with a standard selected from the group consisting of GSM standards and UMTS standards. In one embodiment of the invention, location information is provided to a user as a geographical location. Another embodiment of the invention provides for a base station identifier to be used to determine the at least one cell location. An aspect of this embodiment provides for determining the base station identifier from a look-up table of base station identifiers in a database of network related connection information.

Another embodiment of the invention provides for a cell identifier to be used to determine the at least one cell location. In one aspect of this embodiment, the cell identifier is determined from a look-up table of cell identifiers in a database of network related connection information.

An embodiment of the invention provides that the location information is provided by a visual indicator. In another embodiment, the location information is provided acoustically.

A particularly useful embodiment of the invention provides for the location information to be related to time. Another useful embodiment provides for the storage of location information. Still another useful embodiment provides for the tracking of location information. Location information is automatically provided to a user in one embodiment. In still another embodiment, location information is provided at a user's request.

The invention also provides for a mobile communications device that, in one embodiment, is comprised of (1) a detection device for determining at least one cell location in a communications network in communication with the mobile communications device; and (2) a location indicator for providing location information to a user of the mobile communications device based on the at least one cell location.

In one embodiment of the device, location information is provided as a geographical location. In another embodiment, a base station identifier is used to determine the at least one cell location. In still another embodiment a cell identifier is used to determine the at least one cell location.

To provide a user with location information, one embodiment provides it with a visual indicator. In another embodiment, location information is provided acoustically.

The foregoing has outlined preferred and alternative features of the present invention so that those skilled in the pertinent art may better understand the detailed description of the invention that follows. Additional features of the invention will be described hereinafter that form the subject of the claims of the invention. Those skilled in the pertinent art should appreciate that they can readily use the disclosed conception and specific embodiment as a basis for designing or modifying other structures for carrying out the same purposes of the present invention. Those skilled in the pertinent art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates, schematically, a communications network where the location of a mobile communications device is determined in accordance with an embodiment of the present invention;

FIGS. 2A-2D illustrate a planar frontal view of a cellular phone where various embodiments of the present invention are shown that set forth various modes of presenting relevant information to a user; and

FIG. 3 illustrates a flow chart of an embodiment of the present invention.

### DETAILED DESCRIPTION

Before explaining the FIGUREs, various aspects, embodiments and features of the invention will be described. The present invention sets forth a method for providing location information for mobile communications devices that are connectable with or connected to a mobile communications network. In one embodiment, to be described below, the method provides for the detection of a location or position by the mobile communications device based on its position within the network and using the mobile communications device to indicate such location to a user. In one of the embodiments of the invention, the location is provided as a geographical location such as, for example, a city name, a district name or a even a county name.

A particularly useful embodiment of the invention provides for the mobile communications device to be a mobile or cellular telephone. Of course other embodiments of the invention provide for the mobile communications device to be a laptop or a palm type computer, assuming, of course, that such a device has the capability of being connected or connectable to a communications network. Of course the mobile communications device must be operable in accordance with applicable standards, which are currently either GSM standards or UMTS standards.

An embodiment of the invention provides for a location to be automatically indicated on the mobile communications device while still another embodiment provides for the location to be indicated when the location feature on the device is user activated.

The present invention includes the determination of a location based on the connection of the mobile communications device to the mobile communications network. For example, in one embodiment the location within the communications network is determined based on a base-station or connection antenna identifier or code that identifies a corresponding serving cell. Such an identifier can be made up of a number but it may also be a name describing the geographical location of the base-station. The applicable database can also be used to provide a geographical location associated with a particular identifier. Regardless of how the location is determined, the present invention is intended to be applicable to those situations where a cell or base-station identifier is used to determine a location.

In another embodiment of the invention the relevant base station may only provide an identification code corresponding to its serving cell. In such a case, the location of the serving cell is determined by an identification code or communications cell-ID. In this embodiment the inventive method provides for the comparison of the identified cell-ID with a database that includes relevant network related information, in particular network connection information. For example, the location can be determined based on the communications cell-ID by using a lookup table mapping cell-IDs to specific locations.

In those embodiments of the invention where a database is coupled to the mobile communications device, preferably in the memory of the mobile communications device, network cell-IDs will be related to locations. Such a database can be automatically and/or dynamically updated by a network connection to a server assigned database. As a supplement or alternative, the relevant database can be assigned to a specific network accessible to the mobile communications device.

Because one base station generally serves a communications cell of a specific geographic size, the location will only correspond generally to an approximate location based on the size of the cell. To determine a location more precisely, in one embodiment of the invention, the location is determined based on information from several base stations.

To present location information to a user of the mobile communications device, one embodiment of the invention provides for the location to be provided visually. In particular, such information can be displayed on the screen of the mobile communications device. Another embodiment provides for the location to be acoustically indicated by having the location announced on the mobile communications device's speakers.

An additional embodiment of the invention provides for tracking the detected location and relating it to a corresponding time and date. Another embodiment provides for the storage of such information, which could include storage in a central location in a memory storage medium specifically allocated to the pertinent mobile communications device. This kind of information would be particular useful in tracking and tracing the movement of the mobile communications device and, implicitly, its user. Such a feature would be particularly attractive to commercial users to keep track of the activities of salesmen, service personnel, delivery people, and the like.

One embodiment of the invention can be implemented with appropriate software that changes the programming of the mobile communications device. Thus, the present invention can be represented by a computer software product adapted or programmed for executing the above described inventive methods, which computer software product lies within the intended scope of the present invention. The present invention can also be implemented by way of a storage medium, such as a microchip, with electronically readable control instructions that are adapted to execute, when inserted in a mobile communications device, the method or methods described above.

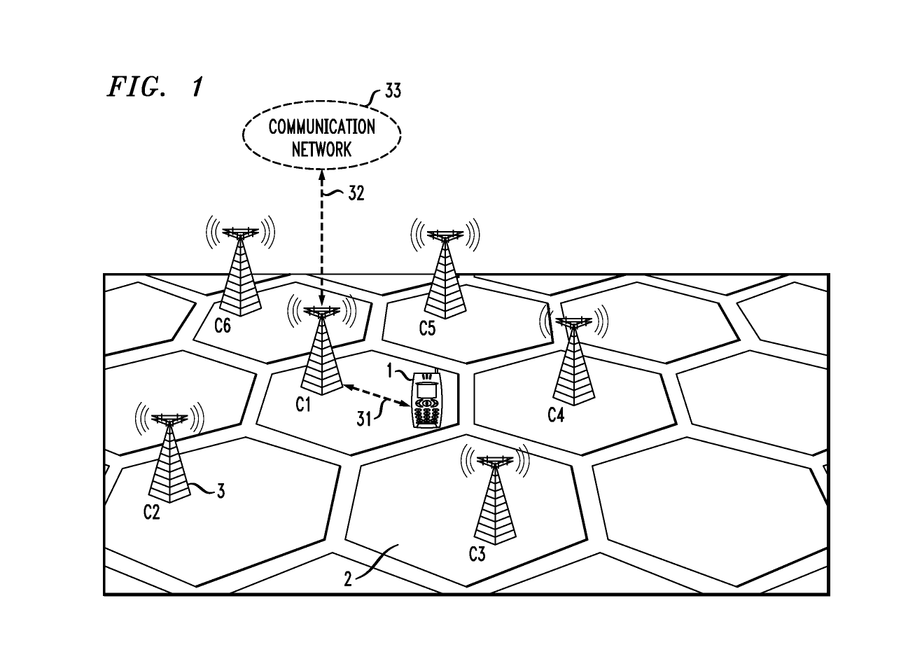

Turning now to FIG. 1, illustrated, schematically, is a communications network 33 where the location of a mobile communications device 1 is determined in accordance with an embodiment of the present invention. In the illustrated embodiment, the mobile communications device 1 is a mobile phone. The illustrated communications network 33 may be a network operated in accordance with GSM or UMTS standards. The illustrated communications network may also be a CDMA network.

A cellular network 34 is shown schematically with each cell 2 having a corresponding antenna 3 or base station connected via a network connection 32 to a communications network 33. As will be understood by those skilled in the pertinent art, only a small portion of the antennas 3 and network connections 32 are shown. A mobile communications device 1, in this case a cellular telephone, is located in cell C1 and is able to verify such position because it has an established communication connection 31 with an antenna 3 servicing cell C1.

Each antenna 3 or base-station thru which a mobile communications device 1 establishes a communications connection 31 has its own unique identifier, such as, for example, a name or a number. This name, number, or other identification feature will frequently be associated with the geographical area or location where the antenna or base-station is positioned. Usually it will be the name of a nearby town or city. It could also be a portion or area of a town or city, when the town or city contains several antennas or base-stations. As will be hereinafter explained in more detail, this name is generally communicated to the user by being displayed on the screen of the mobile communications device 1.

In most cases the mobile communications device 1 will also receive signals originating from other antennas 3 or base stations, such as, in the instant example, adjacent cells C2 to C6. Utilizing known signal processing techniques, these additional signals can be used to determine or calculate a more precise location of the mobile communications device 1 in cell C1.

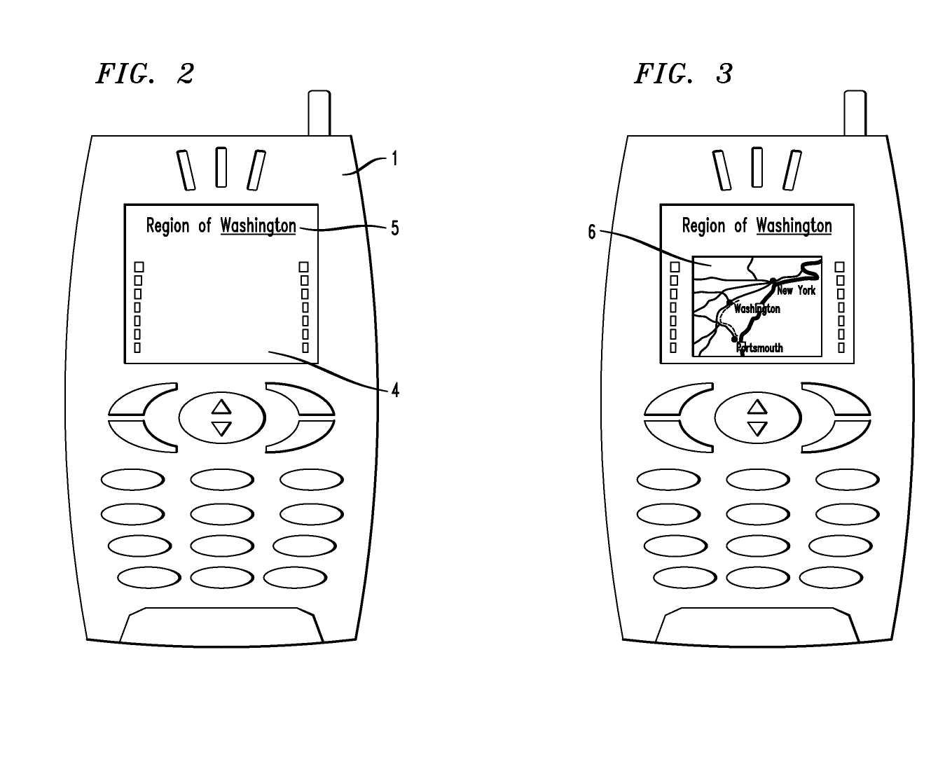

Turning now to FIGS. 2A-2D, illustrated are planar frontal views of a mobile communications device 1, in this case a cellular phone, showing various features or embodiments of the present invention. In FIG. 2A a visual indication 5 of the present location of the mobile communications device 1 is illustrated. The visual indication 5 of the location is displayed on the screen 4 of the mobile communications device 1. As the illustrated embodiment shows, the actual location of the mobile communications device, in this case, is Washington, D.C. or a region in or near Washington, D.C. The location or the name of the base-station 3 in communication with the mobile communications 1 is displayed on the main screen 4 under the icon bar, although the name could be displayed anywhere and still be within the intended scope of the present invention.

On screen 4 in FIG. 2B a track or tracing of the present and previous locations of the mobile phone are shown on a map 6 displayed on the screen 4. As indicated by an inserted broken line 6A, the previous mobile phone positions were around Portsmouth and the present actual position is near Washington D.C. FIG. 2C shows a mobile phone where previous locations and the approximate time the mobile phone was at each such location are listed. This information can be presented to a user as a list or, as shown, a table 7. FIG. 2D is a zoomed-in enlarged view 9 of the map 8 shown in FIG. 2B and displays more detailed information to the user. It illustrates how prominent facilities in an area around the actual location of the mobile phone can be shown by symbols or icons representing such details as nearby gas stations, malls, supermarkets, and so on. Also shown in the upper part of screen 4 is a scrolling legend 8 showing a series of previous mobile phone positions and times at such positions. The information shown by the scrolling legend 8 will generally correspond to information shown in tabular form on the screen 4 in FIG. 4C.

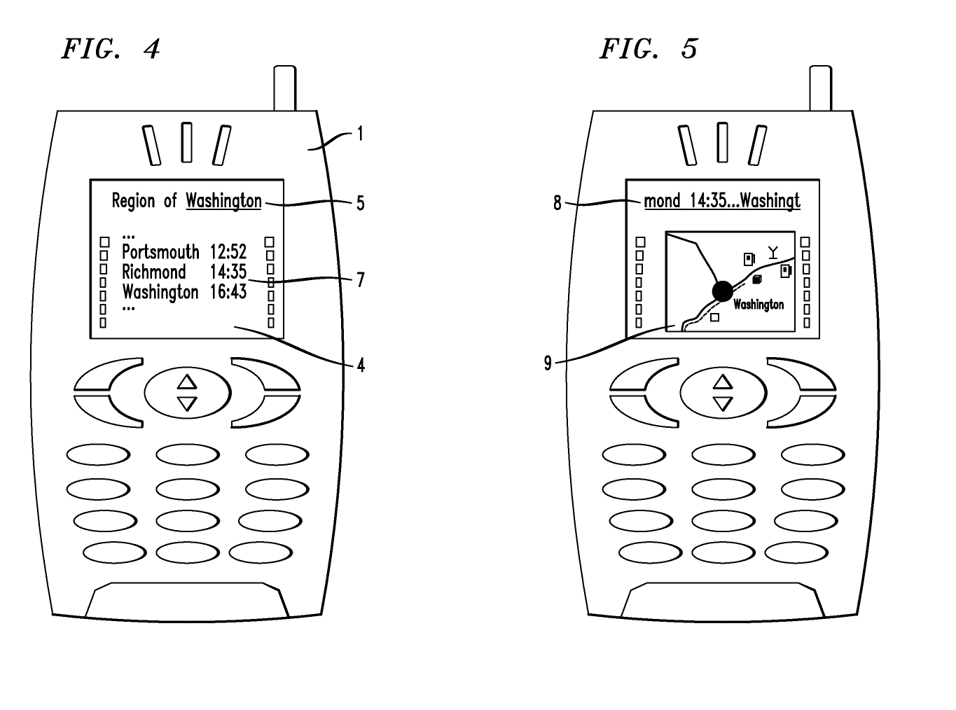

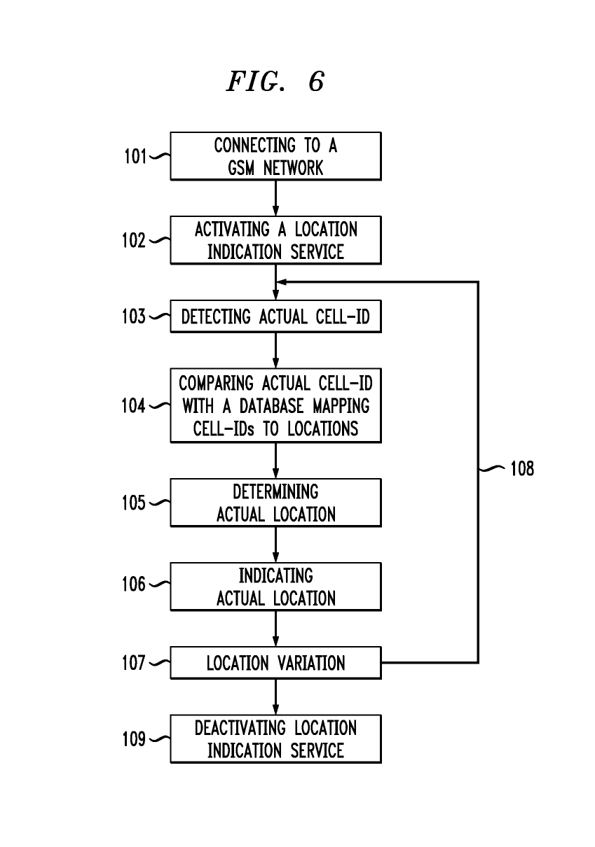

Turning now to FIG. 3, illustrated is a flow chart of one embodiment of the present invention. In describing this embodiment, reference will hereinafter be made to FIGS. 1-2D. In the illustrated embodiment, a mobile communications device 1 is connected with a network 33 in accordance with GSM standards in a connecting to a GSM step 101. As described above, the location indication feature of the invention can be automatically or manually activated in a activating a location indication service step 102. The mobile communications device 1 detects or recognizes the cellular-ID of the serving cell 2 via its connection to such cell 2 in a detecting actual cell-ID step 103. To determine the actual approximate location of the mobile communications device 1, in particular its actual geographical location, the actual cell-ID is compared with a database mapping cell-IDs to locations, in particular geographical locations, in a comparing actual cell-ID with a database mapping cell-ID's to locations step 104. This database can be stored in the mobile communications device's memory. In a determining actual location step 105, the actual location of the mobile communications device 1 is determined and indicated visually on the mobile phone screen 4 in an indicating actual location step 106. If the mobile communications device 1 is moving and enters into another serving cell 2, a location variation is detected in a location variation step 107 and a loop 108 is made to the previous detecting actual cell-ID step 103 and steps 103 to 107 are repeated. If the user is not interested in where the mobile communications device is located, the location indication service can be deactivated manually by the user in a deactivating location indication service step 109.

As will be understood by those of ordinary skill in the pertinent art, the present invention can be embodied in other specific forms without departing from the spirit or intended scope of the present invention. Therefore, the present examples and embodiments are to be considered in all respects as illustrative and not restrictive, and the invention is not to be limited to the details given herein.

Although the present invention has been described in detail, those skilled in the pertinent art should understand that they can make various changes, substitutions and alterations herein without departing from the spirit and scope of the invention in its broadest form.

What is claimed is:

1. A method of providing location information to a user of a mobile communications device, comprising:
determining a cell location within a communications network that is in communication with said user's mobile communications device;
utilizing said cell location to determine a geographic location of said user's mobile communications device; and
providing said geographic location to said user via said user's mobile communications device.

2. The method as recited in claim 1 wherein said communications network is operated in accordance with a standard selected from the group consisting of GSM standards and UMTS standards.

3. The method as recited in claim 1 wherein said communications network is a CDMA network.

4. The method as recited in claim 1 wherein said location information is provided as a geographical location.

5. The method as recited in claim 1 wherein a base station identifier is used to determine said at least one cell location.

6. The method as recited in claim 5 further comprising determining said base station identifier from a look-up table of base station identifiers in a database of network related connection information.

7. The method as recited in claim 1 wherein a cell identifier is used to determine said at least one cell location.

8. The method as recited in claim 7 further comprising determining said cell identifier from a look-up table of cell identifiers in a database of network related connection information.

9. The method as recited in claim 1 wherein said location information is provided by a visual indicator.

10. The method as recited in claim 1 wherein said location information is provided acoustically.

11. The method as recited in claim 1 wherein said location information is related to time.

12. The method as recited in claim 11 wherein said location information is stored.

13. The method as recited in claim 1 further comprising tracking said location information.

14. The method as recited in claim 1 wherein said location information is automatically provided.

15. The method as recited in claim 1 wherein said location information is provided at a user's request.

16. A mobile communications device, comprising:
a detection device for detecting and determining a geographic location of a cell location within a communications network that is in communication with a mobile communications device; and
a location indicator for providing a user of said communications device said geographic location via said mobile communications device.

17. The mobile communications device as recited in claim 16 wherein a base station identifier is used to determine said cell location.

18. The mobile communications device as recited in claim 16 wherein a cell identifier is used to determine said cell location.

19. The mobile communications device as recited in claim 16 wherein said location information is provided by a visual indicator.

20. The mobile communications device recited in claim 16 wherein said location information is provided acoustically.

21. A digital storage medium, comprising:
electronically readable control instructions for controlling a mobile communications device, said control instructions causing said mobile communications device to;
detect and determine a geographic location of a cell location in a communications network that is in communication with said mobile communications device; and
provide said geographic location to a user of said mobile communications device based on said cell location.
